(19) United States
(12) Patent Application Publication
(10) Pub. No.: US 2025/0173244 A1
(43) Pub. Date: May 29, 2025

(54) INTELLIGENT OBJECT HEALING DURING SCRIPT AUTOMATION

(71) Applicant: VERIZON PATENT AND LICENSING INC., Basking Ridge, NJ (US)

(72) Inventors: Karthikeyan KADIRVEL, Chennai (IN); Varalakshmi GANDI, Hyderabad (IN); Anil KUMAR, Hyderabad (IN)

(73) Assignee: VERIZON PATENT AND LICENSING INC., Basking Ridge, NJ (US)

(21) Appl. No.: 18/522,391

(22) Filed: Nov. 29, 2023

(51) Int. Cl. G06F 11/36; G06F 8/38; G06F 40/143

(52) U.S. Cl. CPC G06F 11/3608; G06F 8/38; G06F 40/143

(57) ABSTRACT

In some implementations, the techniques described herein relate to a method including: receiving an expected object and a candidate object; computing a similarity coefficient between the expected object and the candidate object; computing an edit distance between the expected object and the candidate object; computing an embedding similarity between the expected object and the candidate object; and computing a matching score between the expected object and the candidate object based on the similarity coefficient, the edit distance, and the embedding similarity, the matching score representing a likelihood that the candidate object has replaced the expected object.

### BACKGROUND

Automating web interactions entails the development of scripts that programmatically interact with the content of web pages. These scripts typically target specific elements or objects found within web pages, often using Hypertext Markup Language (HTML) as a reference. These scripts are often created separately from the web pages they interact with, which can lead to them becoming unsynchronized with the elements within those web pages over time resulting in errors preventing the execution of the scripts.

### BRIEF DESCRIPTION OF THE DRAWINGS

FIG. 1 is a block diagram of an object healing system according to some of the disclosed embodiments.

FIG. 2 is a flow diagram illustrating a method for computing a similarity score between two objects according to some of the implementations.

FIG. 3 is a flow diagram illustrating a method for healing an automation script according to some of the disclosed embodiments.

FIG. 4 is a flow diagram illustrating a method for healing an object locator according teach or suggest some of the disclosed embodiments.

FIG. 5 is a flow diagram illustrating a method for scoring objects in an interface according to some of the disclosed embodiments.

FIG. 6 is a flow diagram illustrating a method for determining if a page refresh is needed according to some of the disclosed embodiments.

FIG. 7 is a block diagram of a computing device according to some embodiments of the disclosure.

### DETAILED DESCRIPTION

The disclosed embodiments describe techniques for computing the similarities between two data structures, such as UI element definitions (e.g., elements defined in a web interface using HTML or the like).

Generally, automation scripts are written and configured to execute particular test cases, for example signing in to a particular user interface. Automation tools used to perform these tasks will then execute the script by gaining access to the UI, extracting particular elements that relate to authentication, for example, and then enter authentication or other details into the UI elements as instructed by the script. However, during the development process, Application code tends to change often and migrates away from particular designs or naming conventions for UI elements. In some instances, UI element identifiers may change, for example from “email” to “email1” or the like, while the automation script continues to search for the “email” UI element unaware that it must now look for the UI element using the identifier “email1” instead. This results in an unfound element error that accounts for approximately 13-15% of script failure errors. In other instances, errors may include the UI failing to fully load before the script executes, or other errors. However, there is no clear way to segregate these different script error issues from being an environmental issue to an automation fix.

In some implementations, a method includes the evaluation of two distinct entities: an expected object and a candidate object under examination for conformity. These objects may correspond to current user interface element and a previously identified user interface element which may, or may not, correspond to the new element. This assessment procedure is comprised of several quantitative analyses to increasingly improve the confidence that two different elements are actually the same element. first, a similarity coefficient is calculated to ascertain the extent of congruence between the expected and candidate objects. In specific instances, the calculation of the similarity coefficient incorporates the utilization of the ‘Jaccard similarity index’. This involves deconstructing both the expected and candidate objects into discrete sets of string tokens and analyzing the intersection over the union of these sets.

Then, an edit distance is determined, quantifying the minimum number of modifications required to transform the candidate object into the expected object. For the determination of the edit distance, methodologies such as the ‘Levenshtein distance’ may be employed, which measures the least number of edits needed for congruence between the two objects. Additionally, the process involves the computation of an embedding similarity, wherein both objects are represented as vector embeddings, and their alignment is evaluated through cosine similarity metrics. The embedding similarity is ascertained by converting the objects into vector representations and subsequently computing the cosine similarity score between these vectors.

These three analyses (and, in some implementations, further analyses) can then be blended to form a holistic scoring of the similarity between two elements, presented as a matching score. This score synthesizes the outcomes of the similarity coefficient, edit distance, and embedding similarity, thereby providing a composite measure of the likelihood that the candidate object is a viable substitute for the expected object. Such a systematic approach holds significant utility in scenarios where precision in object identification and matching is imperative, such as in advanced data analysis and pattern recognition systems.

In an alternative embodiment, the disclosure encompasses a system for the automatic rectification of references to objects, such as HTML elements, utilizing the previously described algorithm. Initially, it detects anomalies within an automation script, specifically errors linked to an anticipated object locator. Following this, it identifies the most recent successful object associated with the automation script. This identification may involve querying a database that archives objects recognized in prior executions of the script.

Subsequently, the system generates multiple similarity scores. These scores are computed between the aforementioned successful object and various objects extracted from a user interface. The computation of each similarity score within this array includes several steps. It involves calculating a similarity coefficient between the expected object and a candidate object, determining an edit distance between these two objects, and computing an embedding similarity. These calculations collectively contribute to the formulation of a matching score. This score represents the likelihood that a candidate object has superseded the expected object. The system then proceeds to replace the original expected object locator with a new locator. This new locator is linked to the object with the highest similarity score among the evaluated objects. The replacement process may entail generating either a relative or absolute path to this highest scoring object.

Finally, the system completes the execution of the automation script utilizing the newly assigned locator. This completion might include modifications to the automation script to incorporate the use of the new locator. Additionally, the system's operations also encompass determining the necessity of a page reload. This determination is based on a comparison between the current number of objects in the user interface and a previously recorded count of objects. These techniques are embodied within a non-transitory computer-readable storage medium, which facilitates the execution of the outlined steps. Devices, methods, and computer-readable media implementing this system are further disclosed herein.

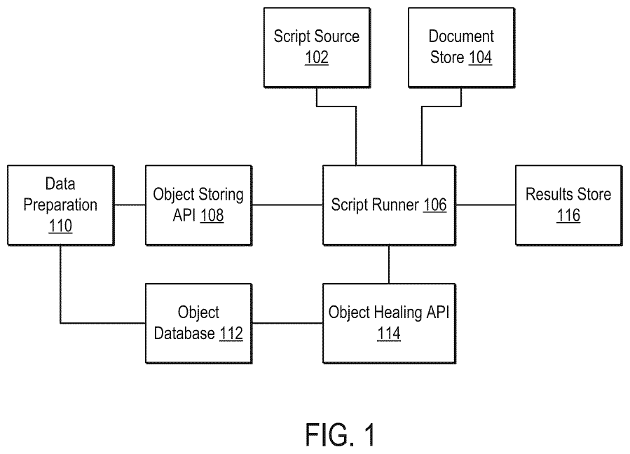

FIG. 1 is a block diagram of an object healing system according to some of the disclosed embodiments.

In an implementation, the system includes a database of scripts (script source 102) and a document store 104. In some implementations, script source 102 can comprise any persistent storage device that can store automation scripts. In some implementations, these automation scripts can comprise executable code for accessing interfaces stored in, for example, document store 104. As one example, the scripts in script source 102 may comprise Python scripts utilizing the Selenium library for programmatically parsing HTML code.

Document store 104 may comprise any storage device or system for storing documents. In some implementations, these documents can comprise documents defining user interface elements, for example HTML documents or the like. In some implementations, the HTML documents can be static HTML documents or dynamically generated HTML documents. In some implementations, the documents can comprise other formats such as extensible Markup Language (XML) documents, JavaScript Object Notation (JSON) documents, etc. In general, any type of computer-readable document that supports the ability to “locate” objects via selectors or locators may be stored in document store 104. In some implementations, document store 104 may be a local database, however in other implementations, document store 104 may comprise a remote storage location. In some implementations, the system may access multiple document stores to retrieve documents.

The system further includes a script runner 106. In some implementations, script runner 106 can comprise a test harness or other framework(s) for identifying, loading, and executing automation scripts stored in script source 102. For example, script runner 106 may comprise a testing framework for executing integration tests. As another example, script runner 106 may comprise a scheduler that schedules automatic operations represented by automation scripts in script source 102.

In some implementations, script runner 106 can load an automation script from script source 102, begin executing the script, and access documents from document store 104 responsive to the script. In some implementations, script runner 106 can further be configured to store objects found in documents retrieved from document store 104. For example, in some implementations, script runner 106 can intercept any commands in automation scripts which attempt to access objects stored in documents from document store 104. For example, script runner 106 can intercept commands in particular scripts, for example the “find_element” command in Selenium scripts. In response, script runner 106 can transmit any found objects to an object storing API 108. In some implementations, this object storing API 108 can receive, for example, a result identifier (indicating the result of the automation script as successful or not), a test identifier, a found object, the source of the page retrieved from document store 104, a uniform resource locator (URL), an identified tag of the object, and an identified value of the selector or locator. In some implementations, the object storing API 108 can transmit the page source and object data to data preparation 110 which can compute a hash of these inputs. In some implementations, data preparation 110 can utilize any one-way hash function such as a SHA-256 hash function to generate a fixed length representation of the page source and object. In some implementations, the use of a hash function can avoid duplicated storage of the same objects and page source combinations and thus reduces storage requirements and complexity. In some implementations, data preparation 110 can then store the retrieved data, indexed by the hash, in an object database 112. As will be discussed, by storing objects successfully found in a given page, object healing API 114 can later retrieve the most recently found objects when an error occurs. In some implementations, script runner 106 can further transmit a count of all objects in a page upon successfully executing an automation script. As will be discussed, this count can be used to confirm whether a page is fully loaded or not.

As illustrated, script runner 106 further communicates with an object healing API 114. In some implementations, script runner 106 can be configured to monitor the automation script for errors. In some implementations, these errors include the automation script search a document for an object (e.g., HTML element) and returning no matches, thus generating an error. In response to such an error, the script runner 106 can provide data about the expected object (e.g., selector, value, page source, etc.) to the object healing API 114 and request the object healing API 114 generate a new locator to use in lieu of the locator of the expected object. In this regard, object healing API 114 can “heal” a broken locator based on the current page source and a last successfully found object (retrieved from object database 112). Details of this process are described at length herein and are not repeated for the sake of clarity.

Finally, script runner 106 can output the results of the automation script to results store 116. In some implementations, script runner 106 can output a result of the automation script to a display. For example, when the automation script comprises a test script, script runner 106 can output the test results to the terminal. Alternatively, or in conjunction with the foregoing, script runner 106 can include persisting a result to results store 116. For example, if the automation script comprises a web scraper, the method may include processing elements of the interface and writing a record to a database based on the content of the interface.

Further operational details of object healing API 114 and other components of FIG. 1 are described more fully below in connection with the flow diagrams.

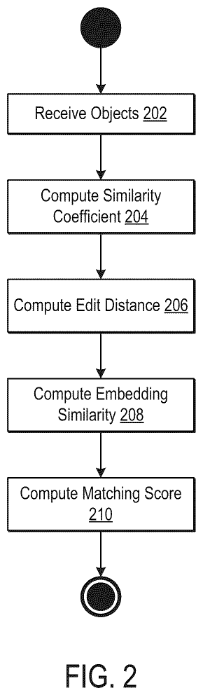

FIG. 2 is a flow diagram illustrating a method for computing a similarity score between two objects according to some of the implementations.

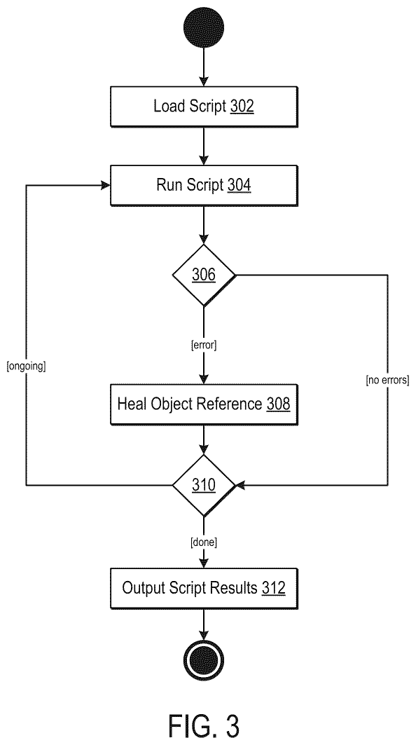

In step 202, the method can include receiving two or more objects. For purposes of illustration, two objects are used as an example and step 202 can include receiving an expected object and a candidate object. In some implementations, the candidate object can be selected via the process described in the method of FIG. 3, the disclosure of which is not repeated herein. For example, in some implementations, the candidate object can comprise a previously identified object with a page corresponding to the expected object.

In some implementations, the object can be a data structure representing part of a user interface, e.g., a webpage or an app flow. In some implementations, the object can be represented by a markup or definitional language, such as Hypertext Markup Language (HTML) for web pages or may other known object definition systems.

In some implementations, a given element of such an interface may include a tag, attributes (stored as key-value pairs), locator, and text or other content. In some implementations, user interfaces may be defined using text or object code that identifies elements of the user interface. For example, an iOS® application may include SwiftUI® statements that identify user interface elements (e.g., “VStack,” “Button,” etc.). Other mobile frameworks may employ similar declarative approaches to defining user interfaces. Further, desktop and embedded applications may employ similar approaches in defining user interface elements. Finally, web-based applications may be delivered in various technologies including, but not limited to, HTML, XML, JSON, or other formats including formats based on open standards (e.g., React, Vue, etc.). In general, any element in a user interface is referred to as a “tag,” properties (both visual and hidden) of elements are referred to as attributes, and locators are referred to any means to identify elements relative to a user interface.

In some implementations, a tag refers to a standard HTML tag, a custom-defined HTML tag (e.g., a web component element name), or other types of element defining tags. Examples of HTML tags include link tags (A), image tags (IMG), container tags (DIV, SECTION, etc.), form tags (FORM), control tags (INPUT, BUTTON, etc.), multimedia tags (AUDIO, VIDEO, etc.), etc. In some implementations, attributes refer to the keys and values assigned to a given HTML element. No limit is placed on the form of these attributes. For example, a BUTTON element may include global attributes such as an id attribute or class attribute as well as element-specific attributes (e.g., type attribute). In some implementations, a locator refers to a string or other data type used to locate the object within the web page. For example, the locator can comprise a Cascading Style Sheet (CSS) selector, an XPath locator, or any similar type of locator. Finally, the object can be associated with text, audio, video, or other non-metadata content. For example, a link tag may include an inner text property storing the link text, an image tag may include a base64-encoded version of the image, etc. Although HTML is used as an example in the above description, the same techniques can be applied to other user interface technologies, including but not limited to those discussed previously.

In step 204, the method can include computing a similarity coefficient between the expected object and the candidate object.

In some implementations, the method may involve transforming the UI objects into sets of tokens for the purpose of computing set similarity. This transformation can be achieved through various methods, each focusing on different aspects of the UI objects and converting those aspects to tokens. For example, tags, attributes, text content, and structural hierarchy can be converted to tokens when forming these sets. As an example, an HTML element (“<a href=‘/’>Home</a>”) can be converted into a set of string token values (“[“tag=a”, “href=/”, “text-Home”]”). Any technique for marshalling an HTML element into a token set representation of its structure may be used.

Once the UI objects are transformed into sets, a variety of set similarity measures can be employed. In some implementations, a Jaccard index for the two objects can be computed. A Jaccard Index, also known as the Jaccard similarity coefficient, is a statistical measure used to gauge the similarity and diversity of sample sets. It is calculated by dividing the number of elements in the intersection of the sets by the number of elements in the union of the sets.

Other techniques apart from the Jaccard index can be used. For instance, the method may include the use of the Dice's Coefficient, which is particularly effective in assessing the similarity between two sets by considering the size of the intersection relative to the size of each set individually. Another alternative is a cosine similarity measure, which computes the cosine of the angle between two vectors in a multi-dimensional space, representing the sets. Alternatively, an overlap coefficient could also be implemented, particularly useful in cases where one set is significantly smaller than the other. This coefficient focuses on the proportion of overlap between the smaller set and the larger set, offering a different perspective on similarity. In other implementations, the method can incorporate a Hamming distance, which counts the number of positions at which the corresponding elements are different. This approach is particularly useful for sets of equal size and can be adapted for sets of differing sizes by considering additional factors, such as set union or padding smaller sets. In other implementations, the method might also consider the use of advanced techniques like machine learning algorithms to compute set similarities. These techniques can include neural network models that are trained to understand complex patterns and relationships between elements in the sets, providing a more adaptive and context-aware similarity assessment. Furthermore, the method may also include hybrid approaches, combining multiple set similarity measures to gain a comprehensive understanding of the similarity between the expected object and the candidate object. This can involve weighted combinations of different similarity coefficients, where each coefficient's weight is determined based on the specific context and nature of the HTML elements being compared.

In step 206, the method can include computing the edit distance between the expected object and the candidate object.

In step 206 of the described method, the method involves calculating the edit distance between two objects: the expected object and the candidate object. This step is used to determine the degree of similarity or dissimilarity between these objects. Edit distance, often known as Levenshtein distance, is a measure of the number of single-character edits (insertions, deletions, or substitutions) required to change one word into another. By computing the edit distance, the method quantifies how closely the candidate object matches the expected object. The algorithm to compute this distance efficiently typically involves dynamic programming, which constructs a matrix to hold distances between substrings of the two objects and calculates the optimal number of edits needed to transform one object into the other.

Moreover, variations of the basic edit distance algorithm, such as the Hamming distance (used when the two objects are of the same length) or the Damerau-Levenshtein distance (which considers transpositions of two adjacent characters as a single edit), can also be applied depending on specific requirements. These variations account for different types of discrepancies that might occur between the expected and candidate objects, offering a flexible approach to measure their similarity.

In some implementations, the edit distance can further be normalized to a value between zero and one. For example, the following normalization function may be used:

$$normalized = 1 - ( \frac{distance}{max ( {s}_{1} , {s}_{2} )} )$$

Here, distance represents the edit distance (e.g., Levenshtein distance) between two strings of lengths s₁ and s₂.

In step 208, the method can include computing the embedding similarity between the expected object and the candidate object.

In some implementations, step 208 entails an approach to computing the embedding similarity between an expected object and a candidate object, leveraging the principles of semantic similarity. This similarity score can be based on the congruence in the meanings or semantic content of two entities, which can vary in form from individual words to complex strings or sentences. In some implementations, the step can utilize pre-trained model embeddings. These embeddings can be high-dimensional vector representations, obtained from advanced machine learning models, which capture the nuanced semantic characteristics of the entities. Each entity, be it a word, string, or sentence, is transformed into this vector space, encapsulating its inherent meaning beyond mere syntactic structure.

Once the entities are represented in this embedding space, the method proceeds to measure the distance between these embeddings. In some implementations, the distance metric employed can be the cosine similarity. Cosine similarity assesses the cosine of the angle between two vectors in the embedding space. This metric is particularly effective as it is sensitive to the orientation of the vectors rather than their magnitude, making it adept at capturing the likeness in the directional alignment of meanings between the two entities. Other measures can be used including, but not limited to, Euclidean distance, Manhattan distance, etc.

By utilizing semantic similarity, the method is capable of discerning a high degree of congruence between objects whose meanings or underlying concepts are closely aligned, even if their syntactic appearances differ. This aspect is particularly beneficial in scenarios where traditional comparison methods based on syntax or surface-level features might overlook deeper semantic connections. The method thus provides a more nuanced and context-aware mechanism for object comparison, essential in applications where understanding the intrinsic meaning is crucial, such as in content categorization, recommendation systems, or semantic search algorithms.

Furthermore, this approach is adaptable to various domains and can be fine-tuned according to the specific requirements of the application, such as adjusting the sensitivity of the similarity scoring to cater to different levels of semantic abstraction or domain-specific nuances. This adaptability, combined with the robustness of the semantic similarity-based approach, makes it a powerful tool in the arsenal of methods for intelligent data analysis and interpretation.

In step 210, the method can include computing a matching score between the expected object and the candidate object based on the similarity coefficient, the edit distance, and the embedding similarity, the matching score representing a likelihood that the candidate object has replaced the expected object.

In some implementations, the method can include combining the similarity coefficient (step 204), the edit distance (step 206), and the embedding similarity (step 208). In some implementations, the method can adjust the similarity score using the edit distance and embedding similarity. For example, the method can utilize the formula s+max(d,e)*(1−s), where s represents the similarity coefficient computed in step 204, d represents the edit distance computed in step 206, and e represents the embedding similarity computed in step 208. In some implementations, the values of the edit distance and embedding similarity can exclude the intersection tags from the two objects.

By combining the similarity coefficient (step 204), the edit distance (step 206), and the embedding similarity (step 208), the method can obtain a more accurate similarity score for UI objects.

FIG. 3 is a flow diagram illustrating a method for healing an automation script according to some of the disclosed embodiments.

In step 302, the method can include loading a script.

In some implementations, the script can include an automation script. In some implementations, an automation script can include an executable program for accessing a system. In some implementations, this system can include a website or server. In some implementations, the automation script can use a framework or library for programmatically accessing, scraping, or otherwise interacting with web content. For example, the automation script may utilize the Selenium library for interacting with HTML content. In some implementations, the script can be part of a test suite. In other implementations, the script can be part of a library for performing automated actions involving web pages and web servers.

In step 304, the method can include running the script.

In some implementations, the method can include executing the script within an automation environment. In some implementations, this automation environment may comprise a test environment. In other implementations, the environment can include any and all resources required to execute the script. In some implementations, the environment includes a script runner that coordinates the running of the script (e.g., timing, resources needed, etc.). In some implementations, the runner can include code for detecting and resolving errors that occur while running the script.

In step 306, the method can include determining if any errors occur while the script is running. If so, the method proceeds to step 308. If not, the method proceeds to step 310.

In some implementations, the errors can include any error that prevents successful completion of the automation script. In some implementations, the errors can include errors that occur when referencing elements of a user interface. For example, the errors can include errors that arise when the automation script references an object in a user interface or other computing interface. For example, the find_element method provided by Selenium may throw or return an error or equivalent result when the automation script attempts to access an object via a CSS, XPath, or other selector and the expected object is not found within a user interface. In some implementations, this scenario may arise when the user interface of an application changes independently of the automation script. For example, a frontend developer may modify the CSS class list or HTML identifier of an element as part of normal operations while the author or maintainer of the automation script is not aware of the change. As a result, when the automation script executes, it will use an old selector or locator and throw an error indicating that the expected object is not found. While no errors occur, the method can include executing the automation script normally. However, when an error occurs the method can proceed to step 308 to attempt to automatically correct the error.

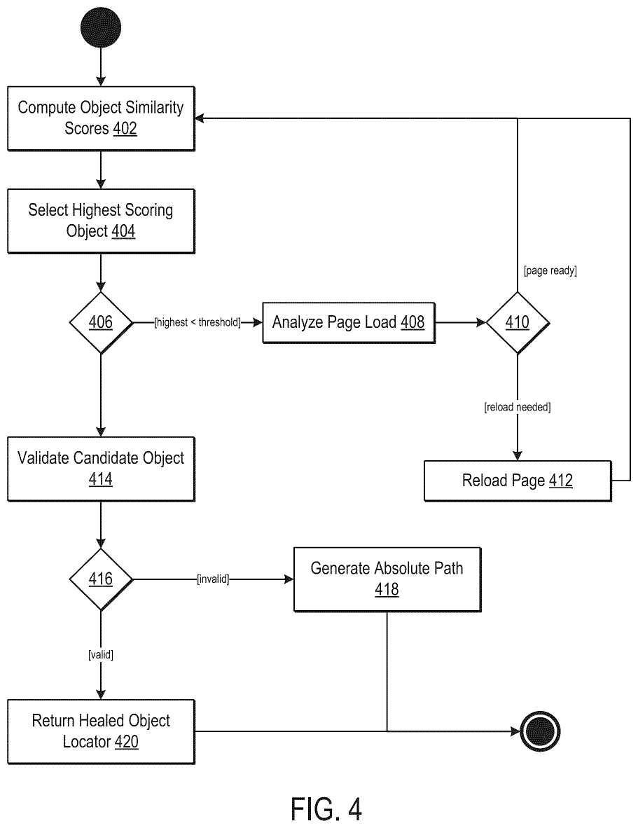

In step 308, the method can include healing an object reference in the script. As discussed above, in some implementations, the errors that occur in step 306 can result from the automation script attempting to access an object (e.g., HTML element) within an interface (e.g., an HTML web page) and failing to identify the expected object. In step 308, the method can replace the expected object's locator or selector with a healed locator or selector. In essence, step 308 can include “re-writing” the expected locator with a new, actual locator appearing in the instant interface. Further details on this step are provided in FIG. 4 and not repeated herein. After replacing the locator with a new locator, the method can re-execute the method that triggered the error (e.g., the find_element method) and thus remedy the error since the healed locator is guaranteed to be within the interface based on the processing of step 308.

In step 310, the method can include determining if the script is still executing. If so, the method returns to step 304 and continues to execute while monitoring for errors. If not, the method proceeds to step 312.

In step 312, the method can include outputting the results of the script.

In some implementations, step 312 can include outputting a result of the automation script to a display. For example, when the automation script comprises a test script, the method can include outputting the test results to the terminal. Alternatively, or in conjunction with the foregoing, the method can include persisting a result to a data storage device. For example, if the automation script comprises a web scraper, the method may include processing elements of the interface and writing a record to a database based on the content of the interface.

FIG. 4 is a flow diagram illustrating a method for healing an object locator according teach or suggest some of the disclosed embodiments.

In step 402, the method can include computing object similarity scores.
some implementations, the method can include receiving an expected object. In some implementations, the expected object can include a data structure storing data regarding object and its context. In some implementations, the expected object can include a locator or selector that identifies a location of the expected object within a user interface. In some implementations, this locator can comprise an XPath locator, a CSS selector or the like. The term locator is used herein to refer to both locators and selectors, as well as other methods for locating an object in an interface. In some implementations, the expected object can include the value of the object (e.g., its tag, content, etc.). In some implementations, the expected object can further include an identifier of the automation script, a source of the interface (e.g., HTML source code), a uniform resource locator (URL) of the interface, a result of the method call triggering the error, and various other details.

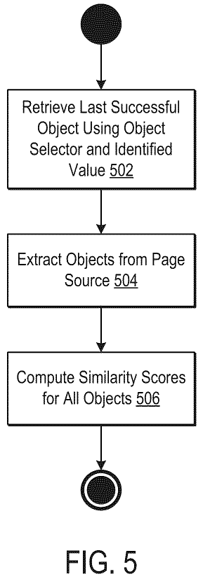

Upon receiving the expected object, the method can compute similarity scores between the expected objects and one or more candidate objects that appear in the interface. As an example, the method of FIG. 2 may attempt to find the expected object in an HTML page having many objects. In step 402, the method computes how similar the expected object is to objects within this page. Details of this process are described in FIG. 5 described next.

FIG. 5 is a flow diagram illustrating a method for scoring objects in an interface according to some of the disclosed embodiments.

In step 502, the method can include retrieving the last successful object for the expected object.

In some implementations, as described in FIG. 1, when an automation script executes without errors, records of matching objects can be recorded in a database. Thus, in step 502, the method uses the locator of the expected object and, optionally, any value content (e.g., tag, id, etc.) to find that most recent successfully matched object for the expected object locator. In some implementations, the database will store the entire object details and thus can return a full object that can be scored, as will be discussed. In general, for most scripts, they will execute without error at least once when first created. Thus, it most cases, the database will include at least one complete object that represents the last time the automation script successfully found the expected object.

In step 504, the method can include extracting all objects from an interface.

In some implementations, the interface may comprise an HTML page. In these implementations, the method can include extracting all of the document object model (DOM) objects in the HTML page. In some implementations, this can include all possible HTML elements in the page. In other implementations, the method can filter the HTML elements to reduce the total size of objects. For example, in some implementations, the method can inspect the tag of the last successful object and filter the HTML elements based on the tag. As one example, if the last successful object is an image tag, the method may only analyze image elements or elements that can be styled as images. In some implementations, the method can analyze the attributes of each object in the page and compare these attributes to the last successful object to determine which objects to further process as described herein. However, in other implementations, the method can simply analyze all objects on page.

In step 506, the method computes similarities between the last successful object and all objects in the interface. In some implementations, the method can utilize the method of FIG. 2 to compute the similarities between the last successful object and the objects in the page source. In some implementations, the method iterates through each element in the page source and computes a similarity accordingly. As a result, the method can output a list of objects in the page that was accessed by the automation script when an error occurs.

Returning to FIG. 4, in step 404, the method ranks the candidate objects scored using the method of FIG. 5 and selects the highest scoring object. In some implementations, the objects in the page are scored using the scoring algorithm described in FIG. 2 and thus each object in an interface is assigned a score between zero and one. In some implementations, the method can order the scored list and select the highest scoring object in the page source which represents the most similar object in the page source that corresponds to the last successful object found in response to the expected object locator. It should be noted here that the use of a last successful object stored in a database can ensure that the method can identify a valid UI element which improves the similarity scoring.

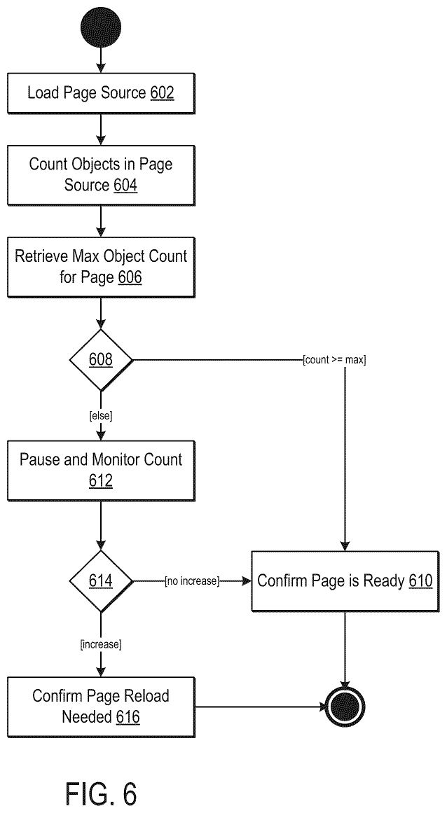

In step 406, the method can include determining if the score of the highest scoring object is greater than a second-highest scoring object, the second-highest scoring object representing a threshold score in which to further proceed. If not, the method proceeds to step 408 where it analyzes the page load to determine if a page reload is needed. Details of step 408 are provided in the description of FIG. 6 and not repeated herein. In step 410, based on the output of step 408, the method determines if the underlying interface or page should be refreshed or reloaded. As discussed in FIG. 6, the method can determine that the page was analyzed before it was ready and thus a reload of the page objects is necessary to obtain a complete list of candidate objects. In this scenario, the method proceeds to step 412 where it reloads the page. In some implementations, this may trigger a re-execution of the automation script. Specifically, after step 412, the method may return to step 402 where the page objects are re-checked to determine if enough objects exists and object similarities are computed.

Alternatively, if the highest scoring candidate object is above the threshold, the method proceeds to step 414 where it validates the highest-scoring candidate object. In some implementations, the method can include generating a new element using a locator of the highest-scoring candidate object (e.g., a CSS or XPath selector), the selector of the expected object, and the source of the web page. This element can then be compared to the highest-scoring candidate object to compute the similarity between the two (e.g., using the method of FIG. 2) in step 416. If the newly generated object is valid, the method may return the locator associated with the highest-scoring candidate object in step 420. In some implementations, this locator can then be used to modify the automation script for future runs. In some implementations, this healed locator can comprise a relative locator as stored in the database.

In contrast, if the method determines that the selected element is not valid, the method can proceed to generate an absolute locator path for the highest-scoring candidate object in step 418. In some implementations, this absolute path can be construed based on the structure of the underlying page and can include an absolute path to the highest-scoring object starting from a root element of the document. In some implementations, the use of an absolute path can be chosen as a fall back as minor changes to the HTML page may trigger additional errors which may be later-healed by the method.

FIG. 6 is a flow diagram illustrating a method for determining if a page refresh is needed according to some of the disclosed embodiments.

In step 602, the method can include loading a current page source for a user interface. As discussed, in some implementations, step 602 can be called upon encountering an error when processing a user interface, web page or the like (e.g., upon detecting an unfound element responsive to a locator or selector).

In step 604, the method can include counting the number of objects currently present in the page source. In some implementations where the user interface is implemented using a markup language, the method may query the DOM of the currently rendered page and obtain a count of all elements. For example, the query find_elements_by_xpath(“//*”) (using Selenium) can be used to retrieve all objects in page source. In other user interface designs, similar methods for obtaining all objects in the interface may be used.

In step 606, the method can include retrieving a maximum object count for the page. In some implementations, as discussed, the method can store objects successfully found when executing an automation script. In some implementations, the system can further store a count of the number of objects in a web page when an automation script passes without errors, thus representing a “maximum” count of objects. In some implementations, a maximum refers to the highest number of objects found during a successful run of an automation script.

In step 608, the method can include determining if the current count of objects is greater than or equal to the maximum number of objects. If so, the method can proceed to step 610 where it confirms that the currently loaded page source represents the entire page for purposes of computing object similarities. As discussed in FIG. 3, after step 610, the method may return and re-compute object similarities with the understanding that the entire page has been loaded.

In contrast, if in step 608, the method determines that the current number of objects is less than a previous maximum number of objects, the method proceeds to step 612 where it pauses and monitors the number of objects in the page source. In some implementations, the method can await further loading of a web page (e.g., due to JavaScript calls, user interactions, etc.). In some implementations, the method can utilize an initialize a timer to pause for a preconfigured length (e.g., five seconds) before re-calculating the total number of objects in the web page (e.g., as done in step 604). For example, using a WebDriver Wait object in Selenium can be used to monitor a page load.

In step 614, the method can include determining if the number of objects in the page source has increased after pausing. This count can be done in the same manner as described in step 604. If no increase is detected, the method can confirm the page has been loaded (step 610). Alternatively, the method may re-execute step 612 a number of times (e.g., four more times) to ensure that no objects are added before proceeding.

If, however, the method detects that the number of objects is increasing, the method proceeds to step 616 where it confirms a page reload is needed. Here, the method can estimate that there is an environment issue that has prevented the page from loading properly and the method can signal a refresh is needed to attempt to load the page properly.

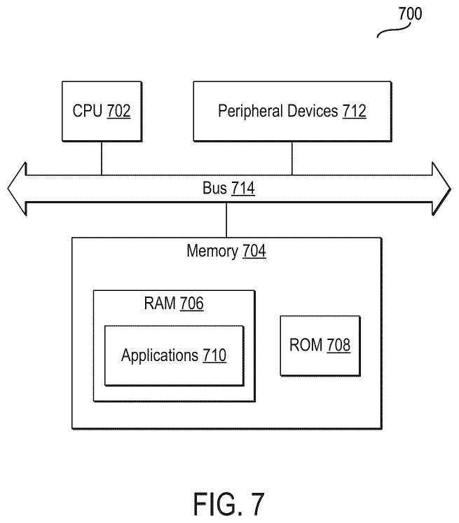

FIG. 7 is a block diagram of a computing device according to some embodiments of the disclosure.

As illustrated, the device 700 includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a memory system including a dynamic random-access memory (DRAM), static random-access memory (SRAM), Flash (e.g., NAND Flash), or combinations thereof. In one embodiment, the bus 714 may comprise a Peripheral Component Interconnect Express (PCIe) bus. In some embodiments, the bus 714 may comprise multiple busses instead of a single bus.

Memory 704 illustrates an example of a non-transitory computer storage media for the storage of information such as computer-readable instructions, data structures, program modules, or other data. Memory 704 can store a basic input/output system (BIOS) in read-only memory (ROM), such as ROM 708 for controlling the low-level operation of the device. The memory can also store an operating system in random-access memory (RAM) for controlling the operation of the device.

Applications 710 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth®, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a processor, an expected object and a candidate object;
computing, by the processor, a similarity coefficient between the expected object and the candidate object;
computing, by the processor, an edit distance between the expected object and the candidate object;
computing, by the processor, an embedding similarity between the expected object and the candidate object; and
computing, by the processor, a matching score between the expected object and the candidate object based on the similarity coefficient, the edit distance, and the embedding similarity, the matching score representing a likelihood that the candidate object has replaced the expected object.

2. The method of claim 1, wherein the expected object and the candidate object each comprise data representing user interface elements.

3. The method of claim 1, wherein computing a similarity coefficient between the expected object and the candidate object comprises computing a Jaccard similarity index between the expected object and the candidate object.

4. The method of claim 3, wherein computing a Jaccard similarity index between the expected object and the candidate object comprises converting both the expected object and the candidate object into sets of string tokens.

5. The method of claim 1, wherein computing an edit distance between the expected object and a candidate object comprises computing a Levenshtein distance between the expected object and a candidate object.

6. The method of claim 1, wherein computing an embedding similarity between the expected object and a candidate object comprises:
converting the expected object and the candidate object to vector embeddings; and
computing a cosine similarity score between the vector embeddings as the embedding similarity.

7. The method of claim 1, wherein computing a matching score between the expected object and the candidate object based on the similarity coefficient, the edit distance, and the embedding similarity comprises computing the matching score according to s+max(d,e)*(1−s), where s represents the similarity coefficient, d represents the edit distance, and e represents the embedding similarity.

8. A non-transitory computer-readable storage medium for tangibly storing computer program instructions capable of being executed by a computer processor, the computer program instructions defining steps of:
detecting an error in an automation script, the error referencing an expected object locator;
identifying a last successful object associated with the automation script;
generating a plurality of similarity scores between the last successful object and a plurality of objects extracted from a user interface;
replacing the expected object locator with a new locator associated with a highest scoring object in the plurality of objects; and
finishing execution of the automation script using the new locator.

9. The non-transitory computer-readable storage medium of claim 8, wherein identifying a last successful object associated with the automation script comprises querying a database of objects identified during previous executions of the automation script.

10. The non-transitory computer-readable storage medium of claim 8, wherein generating a similarity score in the plurality of similarity scores comprises:
computing a similarity coefficient between an expected object and a candidate object;
computing an edit distance between the expected object and the candidate object;
computing an embedding similarity between the expected object and the candidate object; and
computing a matching score between the expected object and the candidate object based on the similarity coefficient, the edit distance, and the embedding similarity, the matching score representing a likelihood that the candidate object has replaced the expected object.

11. The non-transitory computer-readable storage medium of claim 8, the steps further comprising determining whether a page reload is needed based on comparing a number of objects currently in the interface to a previously stored number of objects in the interface.

12. The non-transitory computer-readable storage medium of claim 8, wherein replacing the expected object locator with a new locator associated with a highest scoring object in the plurality of objects comprises generating one of a relative or absolute path to the highest scoring object.

13. The non-transitory computer-readable storage medium of claim 8, wherein finishing execution of the automation script using the new locator comprises revising the automation script to utilize the new locator.

14. A device comprising:
a processor configured to:
receive an expected object and a candidate object,
compute a similarity coefficient between the expected object and the candidate object,
compute an edit distance between the expected object and the candidate object,
compute an embedding similarity between the expected object and the candidate object, and
compute a matching score between the expected object and the candidate object based on the similarity coefficient, the edit distance, and the embedding similarity, the matching score representing a likelihood that the candidate object has replaced the expected object.

15. The device of claim 14, wherein the expected object and the candidate object each comprise data representing user interface elements.

16. The device of claim 14, wherein computing a similarity coefficient between the expected object and the candidate object comprises computing a Jaccard similarity index between the expected object and the candidate object.

17. The device of claim 16, wherein computing a Jaccard similarity index between the expected object and the candidate object comprises converting both the expected object and the candidate object into sets of string tokens.

18. The device of claim 14, wherein computing an edit distance between the expected object and a candidate object comprises computing a Levenshtein distance between the expected object and a candidate object.

19. The device of claim 14, wherein computing an embedding similarity between the expected object and a candidate object comprises:
converting the expected object and the candidate object to vector embeddings; and
computing a cosine similarity score between the vector embeddings as the embedding similarity.

20. The device of claim 14, wherein computing a matching score between the expected object and the candidate object based on the similarity coefficient, the edit distance, and the embedding similarity comprises computing the matching score according to s+max(d,e)*(1−s), where s represents the similarity coefficient, d represents the edit distance, and e represents the embedding similarity.
